(19) United States
(12) Patent Application Publication
(10) Pub. No.: US 2026/0277056 A1
(43) Pub. Date: Sep. 17, 2026

(54) ELECTRONIC DEVICE

(71) Applicant: InnoLux Corporation, Chu-NanMiao-Li County (TW)

(72) Inventors: Hui-Wen SU, Chu-Nan (TW); Wei-Tsung HSU, Chu-Nan (TW); Chi FANG, Chu-Nan (TW)

(21) Appl. No.: 19/551,223

(22) Filed: Feb. 26, 2026

(30) Foreign Application Priority Data
Mar. 17, 2025 (CN) 202510312218.9

(51) Int. Cl. G02F 1/1335; G02F 1/13357

(52) U.S. Cl. CPC G02F 1/133607; G02F 1/133605

(57) ABSTRACT

An electronic device includes a panel and a backlight module. The backlight module is arranged below the panel and includes a light guide plate, a first optical element, a second optical element and a third optical element. The first optical element is disposed on the light guide plate and includes a first prism structure and an optical structure, wherein the first prism structure faces the light guide plate, and the optical structure faces the panel. The second optical element is disposed on the first optical element and includes a second prism structure facing the panel, wherein a vertex angle of the second prism structure is greater than or equal to 120 degrees and smaller than or equal to 170 degrees. The third optical element is disposed on the second optical element and includes a third prism structure facing the panel.

### CROSS-REFERENCE TO RELATED APPLICATIONS

This application claims the benefits of the Chinese Patent Application Serial Number 202510312218.9, filed on Mar. 17, 2025, the subject matter of which is incorporated herein by reference.

### BACKGROUND

### Field of the Disclosure

The present disclosure relates to an electronic device and, more particularly, to an electronic device with a wide viewing angle.

### Description of Related Art

Current displays typically use either LCD or OLED panels, which present a trade-off between performance and longevity. OLEDs offer superior performance in brightness, contrast, and viewing angle but have a poor lifespan. Conversely, long-lasting LCDs suffer from inferior performance, particularly a narrow viewing angle that fails to meet user needs, thus necessitating an improved technology to address these shortcomings.

### SUMMARY

The present disclosure provides an electronic device, which comprises: a panel; and a backlight module disposed below the panel and including: a light guide plate; a first optical element disposed on the light guide plate and provided with a first prism structure and an optical structure, wherein the first prism structure faces the light guide plate and the optical structure faces the panel; a second optical element disposed on the first optical element and provided with a second prism structure facing the panel, wherein a vertex angle of the second prism structure is greater than or equal to 120 degrees and smaller than or equal to 170 degrees; and a third optical element disposed on the second optical element and provided with a third prism structure facing the panel.

The present disclosure further provides an electronic device, which comprises: a panel; and a backlight module disposed below the panel and including: a light guide plate; an optical film assembly disposed on the light guide plate; and a wide viewing angle film disposed on the optical film assembly, wherein, along an arrangement direction of the panel and the backlight module, a distance between the panel and the wide viewing angle film is between 50 and 100 μm.

Other novel features of the disclosure will become more apparent from the following detailed description when taken in conjunction with the accompanying drawings.

### BRIEF DESCRIPTION OF DRAWINGS

FIG. 1A shows an exploded view of an electronic device according to an embodiment of the present disclosure;

FIG. 1B shows a side view of an electronic device according to an embodiment of the present disclosure;

FIG. 2A schematically illustrates a side view of the first optical element according to an embodiment of the present disclosure;

FIG. 2B shows the optical structure of the first optical element according to an embodiment;

FIG. 2C shows the optical structure of the first optical element according to another embodiment;

FIG. 3 is a schematic diagram of an electronic device according to another embodiment of the present disclosure;

FIG. 4A shows the relationship between the FWHM viewing angle and the refractive index of film measured by experiments;

FIG. 4B shows the relationship between the FWHM viewing angle and the vertex included angle of film measured by experiments;

FIG. 5 is an optical analysis diagram of an electronic device according to an embodiment of the present disclosure;

FIG. 6 is a schematic diagram of an electronic device according to another embodiment of the present disclosure;

FIG. 7A shows a side view of the wide viewing angle film;

FIG. 7B shows a detailed structural diagram of the wide viewing angle film according to an embodiment of the present disclosure;

FIG. 7C shows detailed structural diagram of the wide viewing angle film according to another embodiment of the present disclosure; and

FIG. 8 is a curve showing viewing angle versus brightness measured for an electronic device according to an embodiment of the present disclosure.

### DETAILED DESCRIPTION OF EMBODIMENT

The following embodiments are illustrative and not meant to limit the scope of the present disclosure. A feature described in an embodiment may be applied to or combined with other embodiments.

The terms “comprise”, “have”, or “include” are open-ended and do not exclude additional, unrecited elements, except otherwise specified.

Unless otherwise specified, ordinal numbers, such as “first” or “second”, are only used to distinguish elements and do not imply a specific order, rank, or importance.

Unless otherwise specified, “A or B” (or “A and/or B”) means A, B, or both. “A and B” means both A and B.

Relative terms, such as “top”, “upper”, “bottom”, as well as “on”, “above”, “below”, or “between”, are used to describe the relative positions which may be interpreted to include their translation, rotation, or reflection.

Furthermore, the terms recited in the specification and the claims such as “above”, “over”, “on”, “below”, or “under” are intended that an element may not only directly contacts other element, but also indirectly contact the other element.

Furthermore, the term recited in the specification and the claims such as “connect” is intended that an element may not only directly connect to other element, but also indirectly connect to other element. On the other hand, the terms recited in the specification and the claims such as “electrically connected” and “coupled” are intended that an element may not only directly electrically connect to other element, but also indirectly electrically connect to other element.

In addition, in the specification and claims, the term “almost”, “about”, “approximately” or “substantially” usually means within 20%, 10%, 5%, 3%, 2%, 1% or 0.5% of a given value or range. The given quantity is an approximate quantity, which means that the meaning of “almost”, “about”, “approximately” or “substantially” may still be implied in the absence of a specific description of “almost”, “about”, “approximately” or “substantially”. In addition, the terms “ranging from the first value to the second value” and “range between the first value and the second value” indicate that the range includes the first value, the second value, and other values between the first value and the second value.

In the present disclosure, if the first value is equal to the second value, it implies that there may be an error of about 10% between the first value and the second value. If the first direction is perpendicular to the second direction, the angle between the first direction and the second direction may be 80 to 100 degrees. If the first direction is parallel to the second direction, the angle between the first direction and the second direction may be −10 to 10 degrees.

The electronic device of the present disclosure may include a light-emitting device, a display device, and/or an automation device, but not limited thereto. The display device may, for example, include liquid crystal, light-emitting diodes, or a combination thereof, but not limited thereto. For ease of explanation, in the following description, the electronic is exemplified by a display device.

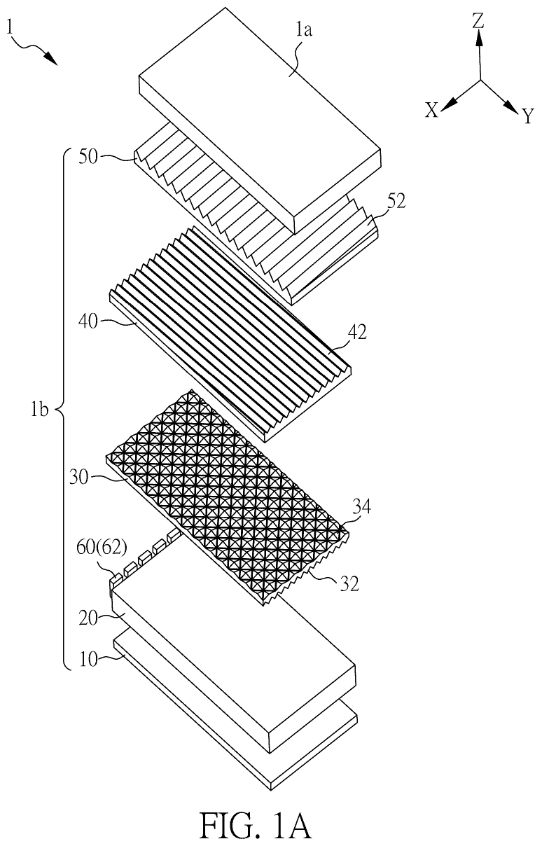

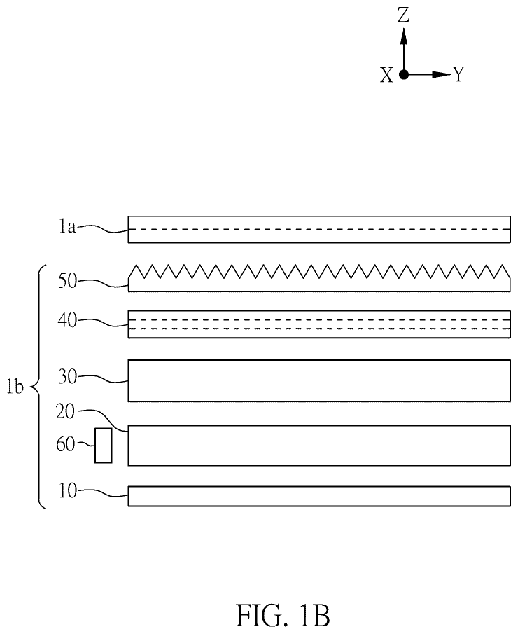

Please refer to FIG. 1A and FIG. 1B, which are respectively an exploded view and a side view of an electronic device 1 according to an embodiment of the present disclosure. The electronic device 1 is illustrated as a liquid crystal display (LCD) panel device. FIG. 1A shows an exploded view of the LCD panel device, and FIG. 1B shows a side view of the LCD panel device. As shown, the electronic device 1 includes a panel 1a and a backlight module 1b. The backlight module 1b is disposed below the panel 1a, and includes a reflective plate 10, a light guide plate 20, a first optical element 30, a second optical element 40, a third optical element 50, and a light source 60 arranged in the Z direction. The light guide plate 20 is disposed on the reflective plate 10, and the light source 60 is disposed adjacent to the light guide plate 20. The first optical element 30 is disposed on the light guide plate 20, the second optical element 40 is disposed on the first optical element 30, and the third optical element 50 is disposed on the second optical element 40.

Still referring to FIG. 1A and FIG. 1B, the first optical element 30 may be a film and include a first prism structure 32 and an optical structure 34. In the Z direction, the first prism structure 32 is arranged on the lower surface of the first optical element 30 and faces the light guide plate 20, and the optical structure 34 is arranged on the upper surface of the first optical element 30 and faces the panel 1a; the second optical element 40 may be a brightness enhancement film (BEF) and include a second prism structure 42 arranged on the upper surface of the second optical element 40 and faces the panel 1a; the third optical element 50 may be a brightness enhancement film (BEF) and include a third prism structure 52 arranged on the upper surface of the third optical element 50 and faces the panel 1a.

The light source 60 has a first extension direction (i.e., the X direction). For example, the light source 60 may include a plurality of light-emitting units 62 arranged along the first extension direction, or the light source 60 may be a long strip-shaped light-emitting unit extending in the first extension direction, but it is not limited thereto. In one embodiment, the light-emitting unit 61 may include a light-emitting diode. The light-emitting diode may include, for example, an organic light-emitting diode (OLED), a sub-millimeter light-emitting diode (mini LED), a micro LED, a quantum dot light-emitting diode (QLED), a fluorescence, a phosphor, or other suitable materials, or a combination thereof, but it is not limited thereto. Therefore, light emitted by the light source 60 enters the light guide plate 20 from one side of the light guide plate 20 adjacent to the light source 60 in the X direction and, after being reflected by the reflective plate 10 and/or guided by the light guide plate 20, enters one side of the first optical element 30 facing the light guide plate 20. Furthermore, the lower surface of the first optical element 30, the second optical element 40, and the third optical element 50 all have a through-type structure. In more detail, the “through-type” herein means, for example, that each prism structure (32, 42, 52) may be regarded as having multiple prism rows extending to two opposite sides of the optical element (30, 40, 50), so that the prism structures (32, 42, 52) may have extension directions (which are respectively a second extension direction, a third extension direction and a fourth extension direction). The first prism structure 32 of the first optical element 30 has a second extension direction perpendicular to the first extension direction (X), the second prism structure 42 of the second optical element 40 has a third extension direction perpendicular to the first extension direction (X), and the third prism structure 52 of the third optical element 50 has a fourth extension direction parallel to the first extension direction (X).

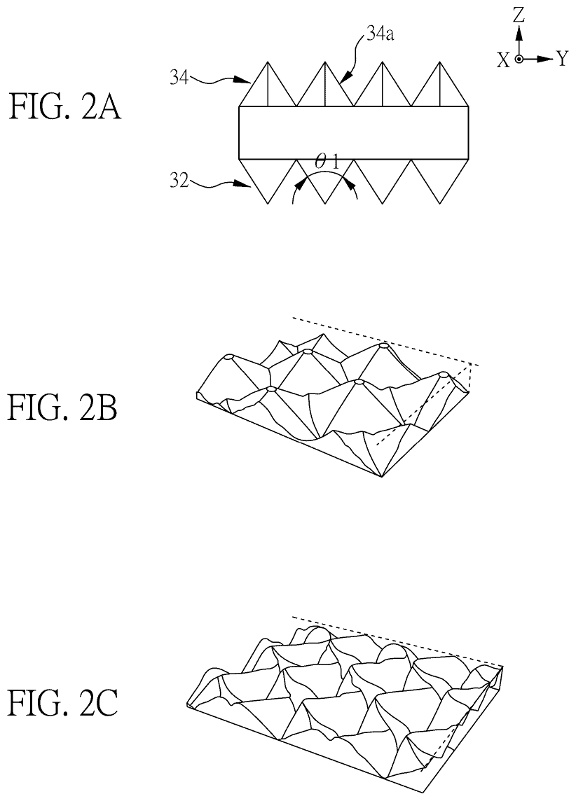

Furthermore, each prism structure (32, 42, 52) may have a vertex angle θ1 (shown in FIG. 2A). The vertex angle θ1 may be defined as the vertex included angle of film of each optical element (30, 40, 50), and the included angle between the extension direction of the prism structure (32, 42, 52) and the first extension direction of the light source 60 is defined as the film arrangement angle of the optical element (30, 40, 50). For example, in FIG. 1A, the first extension direction (X direction) of the light source 60 is perpendicular to the second extension direction (Y direction) of the first prism structure 32, so that the film arrangement angle of the first optical element 30 is 90 degrees. The first extension direction (X direction) of the light source 60 is perpendicular to the third extension direction (Y direction) of the second prism structure 42, so that the film arrangement angle of the second optical element 40 is 90 degrees. The first extension direction (X direction) of the light source 60 is parallel to the fourth extension direction (X direction) of the third prism structure 52, so that the film arrangement angle of the third optical element 50 is 0 degrees. However, the present disclosure is not limited thereto.

FIG. 2A further schematically illustrates a side view of the first optical element 30, wherein a first prism structure 32 on the lower surface of the first optical element 30 has a vertex angle θ1, and an optical structure 34 on the upper surface of the first optical element 30 is, for example, a pyramid-type structure. Referring to FIG. 1A, the optical structure 34 includes a plurality of protruding structures 34a, each providing a pyramid-like shape. The plurality of protruding structures 34a are arranged in an array, and each protruding structure 34a may provide a pyramid-like effect by protruding, as shown in FIG. 2B. Alternatively, a recess among neighboring protruding structures 34a may also generate a pyramid-like effect, as shown in FIG. 2C, but it is not limited thereto.

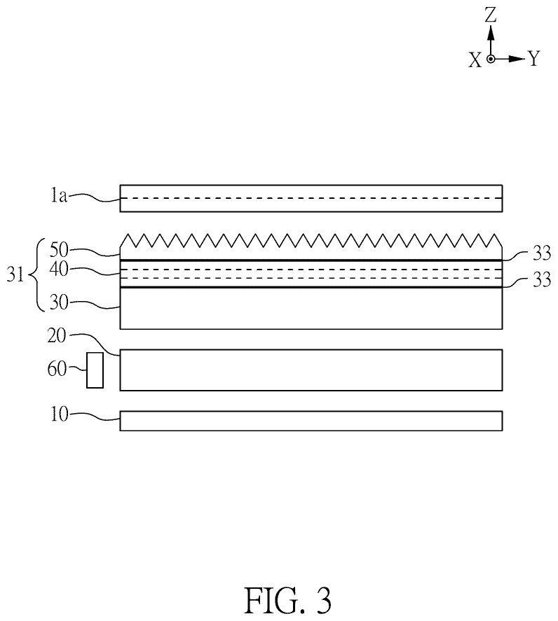

FIG. 3 is a schematic diagram of an electronic device 1 according to another embodiment of the present disclosure, which shows a side view of a liquid crystal display panel device. This embodiment is similar to the embodiment of FIG. 1A and FIG. 1B, except that the first optical element 30 and the second optical element 40 are bonded together with an adhesive 33, and/or the second optical element 40 and the third optical element 50 are bonded together with an adhesive 33. Therefore, for example, a three-in-one bonded optical element 31 including the first optical element 30, the second optical element 40 and the third optical element 50 may be formed, while it is not limited thereto. In addition, the description of other features of this embodiment may be applicable to the embodiment of FIG. 1A and FIG. 1B, and thus a detailed description is deemed unnecessary.

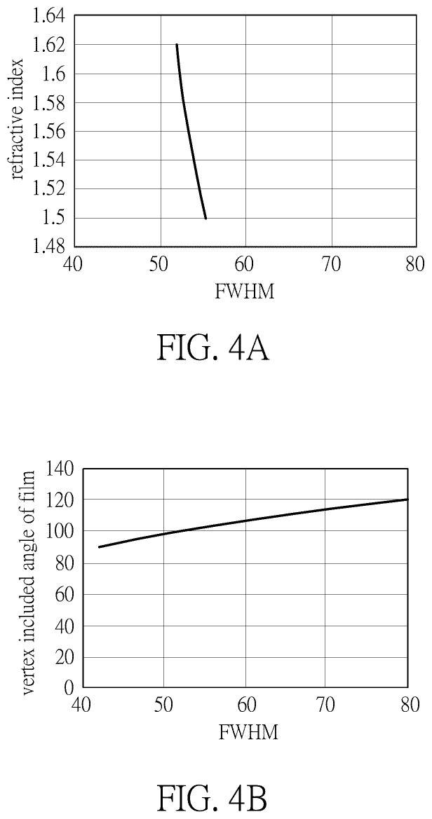

The design principle of the present disclosure for improving the FWHM (Full Width at Half Maximum) viewing angle is further described. First, based on the functional characteristics of the backlight module 1b, the film arrangement angle of the lower surface of the first optical element 30 may be set to 90+/−10 degrees, the film arrangement angle of the second optical element 40 may be set to 90+/−10 degrees, and the film arrangement angle of the third optical element 50 may be set to 0+/−10 degrees. Next, please refer to FIG. 4A, which shows the relationship between the FWHM viewing angle and the refractive index of film measured by experiments (it is noted that there may be errors in the experiments). As shown in FIG. 4A, the relationship between the FWHM viewing angle and the refractive index of film is: when the refractive index is small, the FWHM viewing angle is large. In addition, considering that a large refractive index of film will increase the optical path distance, and a small refractive index of film will decrease the optical path distance, the present disclosure thus designs the second prism structure 42 of the second optical element 40 to have a lower refractive index (e.g., 1.5±0.2), and the third prism structure 52 of the third optical element 50 to have a higher refractive index (e.g., 1.62±0.2). That is, the refractive index of the third prism structure 52 is greater than that of the second prism structure 42, and the difference between the refractive index of the third prism structure 52 and the refractive index of the second prism structure 42 is greater than 0.1. Furthermore, the use of second optical element 40 with low refractive index increases the effective amount of incident light and alleviates the yellowing of film, while the use of the third optical element 50 with high refractive index effectively increases the energy of the light. Therefore, by combining the second optical element 40 with low refractive index and the third optical element 50 with high refractive index, the light extraction efficiency can be improved to meet the requirements (up to 125%) without a noticeable yellowing problem.

Furthermore, please refer to FIG. 4B, which shows the relationship between the FWHM viewing angle and the vertex included angle of film measured by experiments (it is noted that the experiments may have errors). FIG. 4B shows that the relationship between the FWHM viewing angle and the vertex included angle of film is: the larger the vertex included angle of film, the larger the FWHM viewing angle. Furthermore, actual measurements show that, when the vertex included angle of film of the lower surface of the first optical element 30 and the vertex included angle of film of the third optical element 50 are both set to 90 degrees, and when the vertex included angle of film of the second optical element 40 is 90 degrees, the FWHM viewing angle is 42 degrees. When the vertex included angle of film of the second optical element 40 is 105 degrees, the FWHM viewing angle is 57.9 degrees. When the vertex included angle of film of the second optical element 40 is 120 degrees, the FWHM viewing angle is 79.9 degrees. Therefore, in order to obtain a desired FWHM viewing angle, in the present disclosure, the vertex included angle of film of the lower surface of the first optical element 30 (i.e., the vertex angle θ1 of the first prism structure 32) may be set to 90+/−20 degrees, the vertex included angle of film of the third optical element 50 (i.e., the vertex angle θ1 of the third prism structure 52) may be set to 90+/−20 degrees, and the vertex included angle of film of the second optical element 40 (i.e., the vertex angle θ1 of the second prism structure 42) is increased to be greater than or equal to 120 degrees and smaller than or equal to 170 degrees, thereby effectively improving the FWHM viewing angle.

Based on the aforementioned design principle, the curve of FWHM viewing angle versus refractive index of film, and the curve of FWHM viewing angle versus vertex included angle of film, specific features of the first optical element 30, the second optical element 40, and the third optical element 50 that may improve the FWHM viewing angle can be obtained as shown in Table 1 below. Regarding the first optical element 30, the refractive index of the first prism structure 32 thereof may be, for example, between 1.25 and 1.85 (greater than or equal to 1.25 and smaller than or equal to 1.85), the film arrangement angle may be, for example, between 80 and 100 degrees (greater than or equal to 80 degrees and smaller than or equal to 100 degrees), and the vertex included angle of film (i.e., the vertex angle of the first prism structure 32) may be, for example, between 70 and 110 degrees (greater than or equal to 70 degrees and smaller than or equal to 110 degrees), but it is not limited thereto. Regarding the second optical element 40, the refractive index of the second prism structure 42 thereof may be, for example, between 1.2 and 1.8 (greater than or equal to 1.2 and smaller than or equal to 1.8), the film arrangement angle may be, for example, between 80 degrees and 100 degrees (greater than or equal to 80 degrees and smaller than or equal to 100 degrees), and the vertex included angle of film (i.e., the vertex angle of the second prism structure 42) may be, for example, between 120 and 170 degrees (greater than or equal to 120 degrees and smaller than or equal to 170 degrees), but it is not limited thereto. Regarding the third optical element 50, the refractive index of the third prism structure 52 thereof may be, for example, between 1.32 and 1.92 (greater than or equal to 1.32 and smaller than or equal to 1.92), the film arrangement angle may be, for example, between-10 degrees and 10 degrees (greater than or equal to −10 degrees and smaller than or equal to 10 degrees), and the vertex included angle of film (i.e., the vertex angle of the third prism structure 52) may be, for example, between 70 degrees and 110 degrees (greater than or equal to 70 degrees and smaller than or equal to 110 degrees), but it is not limited thereto.

TABLE 1

| | | Film arrangement | Vertex included |
|---|---|---|---|
| | Refractive | angle | angle of film |
| | index | (unit: degree) | (unit: degree) |
| Third optical | 1.32~1.92 | −10~10 | 70~110 |
| element 50 | | | |
| Second optical | 1.2~1.8 | 80~100 | 120~170 |
| element 40 | | | |
| First optical | 1.25~1.85 | 80~100 | 70~110 |
| element 30 | | (lower surface) | (lower surface) |

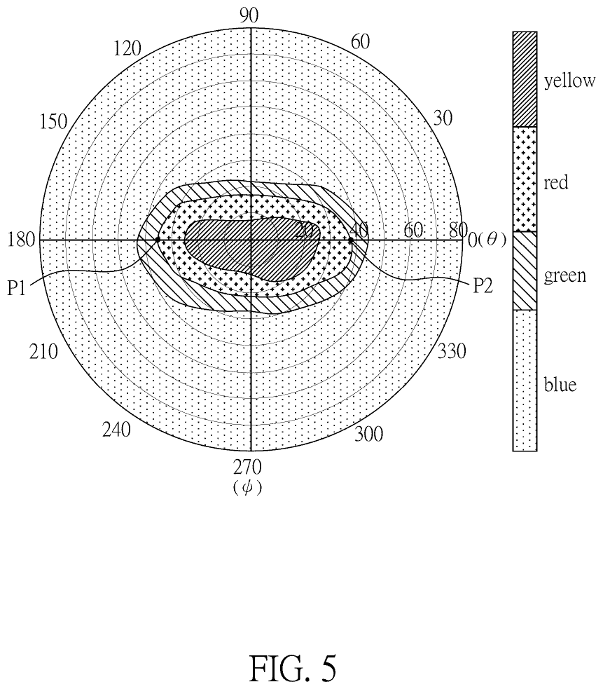

FIG. 5 is an optical analysis diagram of an electronic device 1 according to an embodiment of the present disclosure, which is measured under the following conditions: the first optical element 30 has a refractive index of 1.55, a film arrangement angle of 90 degrees and a vertex included angle of film of 90 degrees, the second optical element 40 has a refractive index of 1.5, a film arrangement angle of 90 degrees and a vertex included angle of film of 120 degrees, and the third optical element 50 has a refractive index of 1.62, a film arrangement angle of 0 degrees and a vertex included angle of film of 90 degrees. The optical analysis diagram may include, for example, an azimuth angle (ψ) ranging from 0 degrees to 360 degrees and an inclination angle (θ) ranging from 0 degrees to 80 degrees. The optical analysis diagram is measured approximately at the center of the electronic device 1, wherein an azimuth angle of 270 degrees is, for example, close to the light source 26, and an inclination angle of 0 degrees is, for example, in the direction of a normal viewing angle (e.g., the Z direction). A larger inclination angle indicates a larger inclination angular magnitude with respect to the Z direction. Furthermore, on the optical analysis diagram, the area marked in blue represent an area with no light or light brightness below a specific value, while the areas marked in green, red, and yellow represent the range covered by the light packet. The brightness of the yellow area is greater than that of the red area, and the brightness of the red area is greater than that of the green area. As can be seen from the optical analysis diagram, after the light provided by light source 26 passes through the optical elements (30, 40, 50), the light packet may be close to the normal viewing angle. Therefore, electronic device 1 may achieve high light extraction efficiency. Furthermore, the FWHM viewing angle of electronic device 1 is approximately 79-80 degrees, which is very close to the FWHM viewing angle of an OLED panel and may meet user needs. The FWHM viewing angle in the present disclosure is illustrated by, for example, FIG. 5, which is determined by using a horizontal line (e.g., a horizontal line with an azimuth angle of 0 degrees to 180 degrees) passing through the maximum brightness. The sum of the inclination angles of the two intersection points (P1, P2) located at half the maximum brightness, for example, point P1 (e.g., an inclination angle of approximately 35 degrees) to point P2 (e.g., an inclination angle of approximately 38 degrees), and thus the FWHM viewing angle is the sum of the two inclination angles (approximately 73 degrees), but it is not limited thereto.

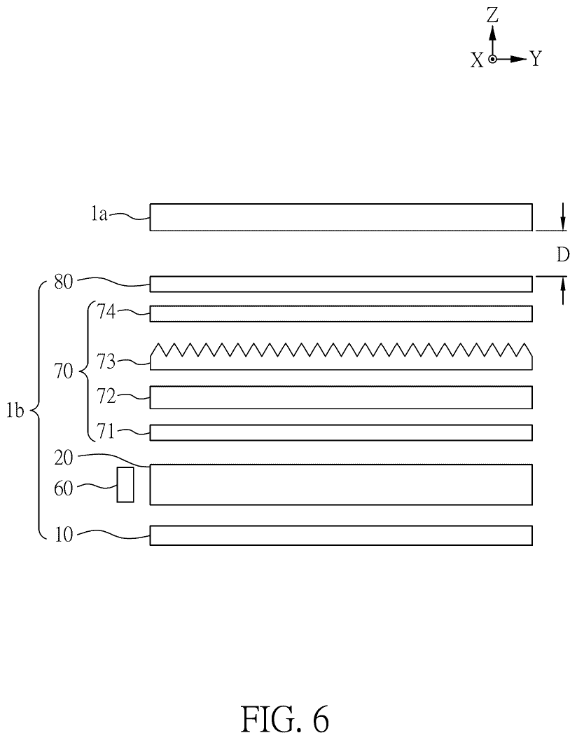

FIG. 6 is a schematic diagram of an electronic device 1 according to another embodiment of the present disclosure. The electronic device 1 is exemplified by a panel device. The electronic device 1 includes a panel 1a and a backlight module 1b. The backlight module 1b is disposed below the panel 1a, and includes a reflective plate 10, a light guide plate 20, an optical film assembly 70, a wide viewing angle film 80 and a light source 60. The light guide plate 20 is disposed on the reflective plate 10, and the light source 60 is disposed adjacent to the light guide plate 20. The optical film assembly 70 is disposed on the light guide plate 20, and the wide viewing angle film 80 is disposed on the optical film assembly 70. Along the arrangement direction of the panel 1a and the backlight module 1b (e.g., along the Z direction), a distance D between the panel 1a and the wide viewing angle film 80 is between 50 and 100 micrometers (μm) (50 μm≤D=100 μm), but it is not limited thereto.

In one embodiment, as shown in FIG. 6, the optical film assembly 70 includes a first optical element 71, a second optical element 72, a third optical element 73 and a fourth optical element 74. The first optical element 71 is disposed on the light guide plate 20, the second optical element 72 is disposed on the first optical element 71, the third optical element 73 is disposed on the second optical element 72, and the fourth optical element 74 is disposed on the third optical element 73. The first optical element 71 is, for example, a diffuser, the second optical element 72 is, for example, a film having a through-type brightness enhancement film structure, the third optical element 73 is, for example, a film having a through-type brightness enhancement film structure, and the fourth optical element 74 is, for example, a diffuser, but it is not limited thereto. In other embodiments, the optical film assembly 70 may also be a structure including the first optical element 30, the second optical element 40 and the third optical element 50 as in the embodiment of FIG. 1B or a variation thereof, or may be other backlight structures having multi-layer films. The present disclosure does not specifically limit the structure of the optical film assembly 70.

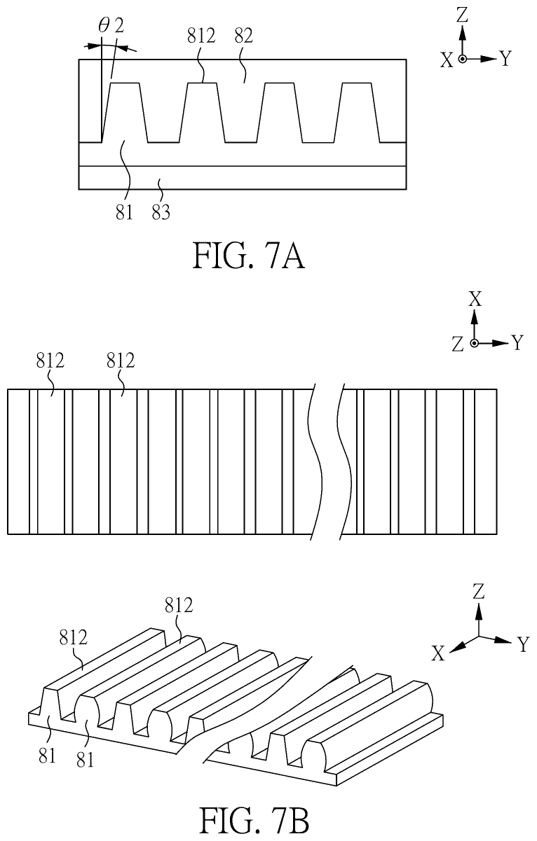

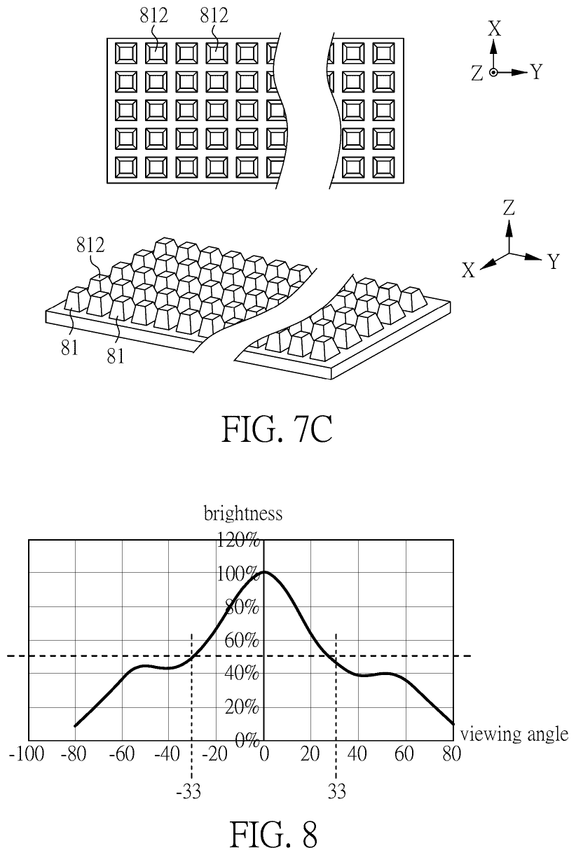

Next, please refer to FIG. 7A, which shows a side view of the wide viewing angle film 80, and FIG. 7B and FIG. 7C, which show detailed structural diagrams of the wide viewing angle film 80 according to different embodiments. The wide viewing angle film 80 includes a first structure 81, a second structure 82 and a bottom structure 83. The bottom structure 83 is disposed on the optical film assembly 70, the first structure 81 is disposed on the bottom structure 83, and the second structure 82 is disposed on the first structure 81. The materials of the bottom structure 83, the first structure 81, and the second structure 82 may be, for example, UV adhesive or other transparent insulating materials, but it is not limited thereto. The refractive index of the first structure 81 is greater than the refractive index of the second structure 82 and the refractive index of the bottom structure 83. For example, the refractive index of the bottom structure 83 is between 1.5 and 1.57 (greater than or equal to 1.5 and smaller than or equal to 1.57), the refractive index of the first structure 81 is between 1.57 and 1.69 (greater than or equal to 1.57 and smaller than or equal to 1.69), and the refractive index of the second structure 82 is between 1.5 and 1.57 (greater than or equal to 1.5 and smaller than or equal to 1.57), while it is not limited thereto. Furthermore, as shown in FIG. 7, the first structure 81 of the wide viewing angle film 80 includes a plurality of protruding structures 812, each having a columnar structure, for example. The angle between one side of the columnar structure and the normal direction (Z direction) of the wide viewing angle film 80 is defined as the structural angle θ2 of the first structure 81, and the structural angle θ2 is between 0 degrees and 45 degrees (0 degrees≤θ2≤45 degrees). In addition, each of the protruding structures 812 may be a columnar structure extending to two opposite sides of the wide viewing angle film 80, or each of the protruding structures 812 may be a plurality of separate columnar structures distributed along the X direction on two opposite sides of the wide viewing angle film 80. Therefore, the wide viewing angle film 80 may be a through-type or non-through-type structure. The through-type structure may be as shown in FIG. 7B, where each protruding structure 812 itself may extend in the X direction. FIG. 7B illustrates protruding structures 812 of different shapes (for example, when viewed along the X direction). In addition, in some embodiments, the protruding structures of the wide viewing angle film 80 may also be arranged alternately with protruding structures of two shapes, as shown in FIG. 7B, while in other embodiments, the protruding structures may include only one shape, but the present disclosure is not limited thereto. In addition, the non-through-type structure may be as shown in FIG. 7C, wherein a plurality of protruding structures 812 are arranged in the X direction and the Y direction.

The structure of the electronic device 1 in FIG. 6 may effectively improve the FWHM viewing angle. FIG. 8 shows a curve of viewing angle versus brightness obtained for the electronic device 1 in FIG. 6. This curve demonstrates that the brightness of the electronic device 1 varies smoothly over a wide viewing angle. Furthermore, the brightness is greater than 50% at viewing angles between-33 degrees and 0 degrees (−33 degrees≤viewing angle≤0 degrees) and between 0 degrees and 33 degrees (0 degrees≤viewing angle≤33 degrees). Therefore, the FWHM viewing angle may be a combination of the viewing angles within the aforementioned range of brightness greater than 50%, approaching 66 degrees, so as to meet user needs. In other embodiments, the FWHM viewing angle may approach 80 degrees, but the present disclosure is not limited thereto.

From the above description, it can be seen that the electronic device of the present disclosure may fully improve the light extraction efficiency, effectively increase the energy of light, and shorten the optical path distance by specially designing the film refractive index, film arrangement angle and vertex included angle of film, or setting a wide viewing angle film, thereby achieving the effect of improving the FWHM viewing angle and successfully realizing an electronic device with a wide viewing angle.

In one embodiment, it may be determined whether a product in contention falls within the protection scope of the present disclosure at least by the presence or absence of components, component configurations and/or operating modes of the product in contention, or by the algorithm of the product in contention, while it is not limited thereto.

The features of the various embodiments of the present disclosure may be mixed and matched as desired as long as they do not violate the spirit of the invention or conflict with each other.

The aforementioned specific embodiments should be construed as merely illustrative, and not limiting the rest of the present disclosure in any way.

1. An electronic device, comprising:
a panel; and
a backlight module disposed below the panel and including:
a light guide plate;
a first optical element disposed on the light guide plate and provided with a first prism structure and an optical structure, wherein the first prism structure faces the light guide plate and the optical structure faces the panel;
a second optical element disposed on the first optical element and provided with a second prism structure facing the panel, wherein a vertex angle of the second prism structure is greater than or equal to 120 degrees and smaller than or equal to 170 degrees; and
a third optical element disposed on the second optical element and provided with a third prism structure facing the panel.

2. The electronic device as claimed in claim 1, wherein the backlight module further includes a light source adjacent to the light guide plate and having a first extension direction, wherein the first prism structure of the first optical element has a second extension direction perpendicular to the first extension direction, the second prism structure of the second optical element has a third extension direction perpendicular to the first extension direction, and the third prism structure of the third optical element has a fourth extension direction parallel to the first extension direction.

3. The electronic device as claimed in claim 1, wherein a refractive index of the third prism structure is greater than a refractive index of the second prism structure.

4. The electronic device as claimed in claim 3, wherein a difference between the refractive index of the third prism structure and the refractive index of the second prism structure is greater than 0.1.

5. The electronic device as claimed in claim 1, wherein a refractive index of the third prism structure is greater than or equal to 1.32 and smaller than or equal to 1.92, and a refractive index of the second prism structure is greater than or equal to 1.2 and smaller than or equal to 1.8.

6. The electronic device as claimed in claim 1, wherein the optical structure includes a plurality of protruding structures arranged in an array.

7. The electronic device as claimed in claim 1, wherein the first optical element and the second optical element are bonded together with an adhesive, the second optical element and the third optical element are bonded together with an adhesive, or the first optical element and the second optical element are bonded together with an adhesive and the second optical element and the third optical element are bonded together with an adhesive.

8. The electronic device as claimed in claim 1, wherein the backlight module further includes a reflective plate, and the light guide plate is disposed on the reflective plate.

9. An electronic device, comprising:
a panel; and
a backlight module disposed below the panel and including:
a light guide plate;
an optical film assembly disposed on the light guide plate; and
a wide viewing angle film disposed on the optical film assembly, wherein, along an arrangement direction of the panel and the backlight module, a distance between the panel and the wide viewing angle film is between 50 and 100 μm.

10. The electronic device according to claim 9, wherein the wide viewing angle film includes: a first structure; and a second structure disposed on the first structure, wherein a refractive index of the first structure is greater than a refractive index of the second structure, and the first structure includes a plurality of protruding structures.
